(19) United States
(12) Patent Application Publication
(10) Pub. No.: US 2004/0037406 A1
(43) Pub. Date: Feb. 26, 2004

(54) Method and system for exchanging instant messages in a multi-party conference call

(76) Inventor: Christophe Gourraud, Montreal (CA)

Correspondence Address: SANDRA BEAUCHESNE, Ericsson Canada Inc., Patent Department (LMC/UP), 8400 Decarie Blvd., Town Mount Royal, Quebec, H4P 2N2, CA

(21) Appl. No.: 10/227,207

(22) Filed: Aug. 26, 2002

(51) Int. Cl. H04M 1/64; H04M 3/42

(52) U.S. Cl. 379/202.01; 379/88.17

(57) ABSTRACT

A method and system for exchanging instant messages among participants to a conference call, wherein when an instant message is to be sent among the participants, the instant message is addressed by a first participant to the conference call itself, which is identified by a conference call URI. An Application Server (AS) receives the message, and based on a memory-stored correspondence between the conference call URI and the conference call participants, translates the session URI into Public Ids, SIP URIs or any other identifier of each participant, or participant's terminal. The AS further relays the instant message to the other participants by addressing it to each participant's identifier. The memory of the AS is updated as new participants join or leave the conference call, as to always reflect the participants currently involved in the conference call.

### BACKGROUND OF THE INVENTION

1. Field of the Invention

The present invention relates to call conferencing, and in particular to a method and system for exchanging instant messages in a conference call.

2. Description of the Related Art

Voice call conferencing is a concept well known in the art, and exists both in fixed and cellular telephony. Typically, it allows more than two parties, or communication terminals, to be involved in the same communications session. For example, when two parties are involved in a communications session, it may be desirable to invite one or more parties to the same session. This may be achieved by dialling a special code number associated with a call conferencing service activation feature, followed by the identification number of the party to be invited. A telephone switch then connects that party to the ongoing voice call between the first and the second party.

With the fast evolution of telephone networks, various communications protocols have defined new and more flexible manners of handling voice and data call sessions in telecommunications networks. The Session Initiation Protocol (SIP) is an Internet Engineering Task Force (IETF) standard protocol for initiating an interactive user session that may involve multimedia elements such as video, voice, chat, gaming, and virtual reality. Like the Hyper Text Terminal Protocol (HTTP), or the Simple Mail Transfer Protocol (SMTP), SIP works in the Application layer of the Open Systems Interconnection (OSI) communications model. SIP can establish multimedia sessions or Internet telephony calls, and modify, or terminate them. Because SIP supports name mapping and redirection services, it makes it possible for users to initiate and receive communications and services from any location, and for networks to identify the users wherever they are. SIP is a request-response protocol, dealing with requests from clients and responses from servers. Participants are usually identified by SIP Uniform Resource Locators (URLs) or Uniform Resource Identifiers (URIs), although SIP also supports E.164 telephone number addressing. Requests can be sent through any transport protocol, such as the User Datagram Protocol (UDP), the Simple Control Transport Protocol (SCTP), or the Transfer Control Protocol (TCP). SIP determines the end system to be used for the session, the communication media and media parameters, and the called party's desire to engage in the communication. Once these are assured, SIP establishes call parameters at either end of the communication, and handles call transfer and termination. The Session Initiation Protocol is specified in IETF Request for Comments (RFC) 2543, which is herein included by reference.

The Third Generation Partnership Project (3GPP) Technical Specifications (TS) 23.218 and 23.228 Release 5 describe a network reference model and a set of procedures defining how call conferencing is to be performed. Reference is now made to FIG. 1 (Prior Art), which is a high-level network reference model of a 3GPP network 100 for IP Multimedia session handling. Shown in the centre of FIG. 1 is a Serving Call State Control Function (S-CSCF) 102 that is responsible for handling the SIP call sessions and conference calls for the subscribers of network 100 as it is known in the art. S-CSCF 102 is linked via an IP Multimedia Service Control (ISC) interface 104 to an SIP Application Server (AS) 106 that executes various services for setting up, influencing and impacting the SIP services. Also connected to S-CSCF 102 via a similar ISC interface 104 is an IP Multimedia Service Switching Function (IM-SSF) 108, which hosts Customized Applications for Mobile network Enhanced Logic (CAMEL) network features (i.e. trigger detection points, CAMEL Service Switching Finite State Machine, etc). A CAMEL Application Part (CAP) interface 110 connects the IM-SSF 108 with a Camel Service Environment 112 as specified in 3GPP TS 29.078, herein included by reference. An Open Service Access (OSA) service capability server (SCS) 114 interfaces on one side with the S-CSCF 102 via an ISC interface 104,and to the other side to an OSA framework Application Server 116 and provides a standardized way for third party secure access to the IM subsystem. The Application Servers 106 and 108 can also interact with a Multimedia Resource Function Controller (MRFC) 118 via the S-CSCF 102 (ISC 102 and Mr 119 interfaces) in order to control Multimedia Resource Function processing. In particular, an MRFC is responsible for controlling and setting up the resources for a conference call. Finally, a Home Subscriber Server (HSS) 120 connects to the S-CSCF 102 via a Cx interface 122 and is responsible for storing and providing subscriber related information. HSS 120 may also store filtering criteria stating which messages involving subscriber services are to be routed to the AS. The functioning of the network 100 for setting up and caring on SIP-based data calls and conference calls is fully described in the above-mentioned 3GPP technical specifications 23.218 and 23.228 Release 5, which are herein enclosed by reference.

During a conference call it may also be desirable to exchange instant messages in the form of text, voice, video, or data. However, although the above-mentioned 3GPP specifications disclose call case scenarios for conducting conference call, they fail to teach an optimized method for sending instant messages among the participants to a conference call.

Accordingly, it should be readily appreciated that in order to overcome the deficiencies and shortcomings of the existing solutions, it would be advantageous to have a method and system for efficiently exchanging instant messages between the participants, during an ongoing conference call. The present invention provides such a method and system.

### SUMMARY OF THE INVENTION

The invention provides a method and system for exchanging instant messages among participants to a conference call, wherein when an instant message is to be sent to the participants of a conference call, the instant message is addressed by a first participant to the conference call itself, which is identified by an identifier such as for example a conference call URI. An Application Server (AS) receives the message, and based on a memory-stored correspondence between the session URI and the conference call participants, translates the session URI into Public Ids or Session Initiation Protocol (SIP) URIs of each participant to the session. The AS further relays the instant message to the other participants by addressing it to each participant's Public ID or SIP URI. The memory of the AS is updated as new participants join or leave the conference call, as to always reflect the participants currently involved in the conference call.

In one aspect, the present invention is a method for exchanging instant messages between at least a first and second participants to a conference call, the method comprising the steps of:

during the conference call, sending an instant message, from the first participant, to the conference call identified by a conference call identifier;

translating the conference call identifier into an identifier of at least a second participant to the conference call; and

sending the instant message to the second participant to the conference call using the identifier of the second participant.

In another aspect, the present invention is a telecommunications system comprising:

an Application Server (AS) handling a conference call; and

a first participant and a second participant to the conference call;

wherein during the conference call, the first participant sends an instant message to the conference call identified by a conference call identifier, the AS translates the conference call identifier into an identifier of at least the second participant to the conference call, and sends the instant message to the second participant to the conference call using the identifier of the second participant.

### BRIEF DESCRIPTION OF THE DRAWINGS

For a more detailed understanding of the invention, for further objects and advantages thereof, reference can now be made to the following description, taken in conjunction with the accompanying drawings, in which:

FIG. 1 (Prior Art) is a 3^{rd} Generation Partnership Project (3GPP) high-level network reference model for IP Multimedia session handling;

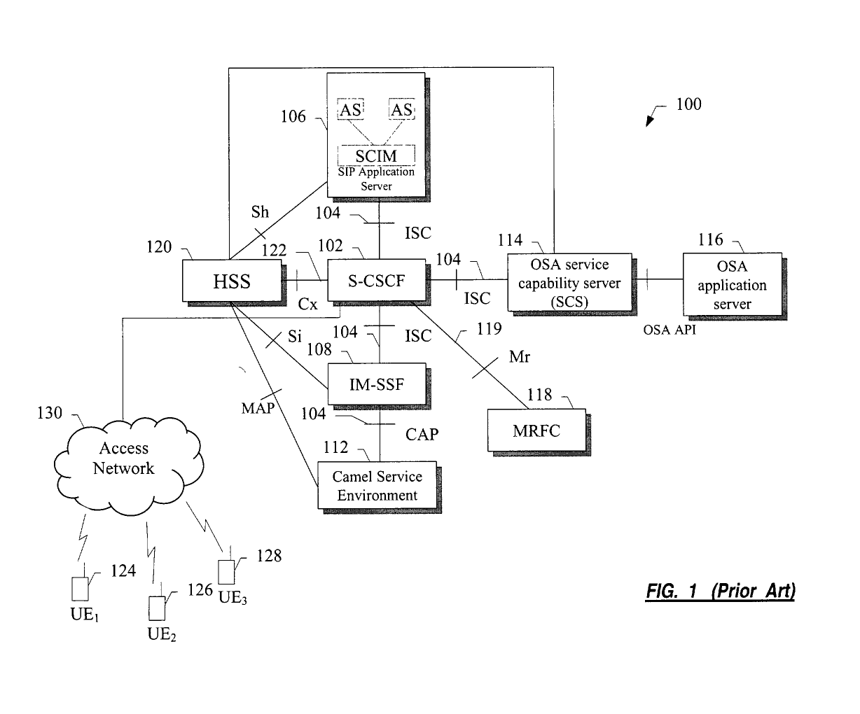

FIG. 2 is an exemplary nodal operation and signal flow diagram of the preferred embodiment of the invention associated with the transmission of an instant message during a Session Initiation Protocol (SIP) conference call;

FIG. 3 is an exemplary illustration of a nodal operation and signal flow diagram of a variant of the preferred embodiment of the invention associated with the transmission of an instant message during an SIP conference call; and

FIG. 4 is an exemplary high-level logical diagram of the memory of an Application Server (AS) AS that stores a correspondence between a conference call Uniform Resource Identifier (URI) and the participants to a conference call.

### DETAILED DESCRIPTION OF THE PREFERRED EMBODIMENTS

The innovative teachings of the present invention will be described with particular reference to various exemplary embodiments. However, it should be understood that this class of embodiments provides only a few examples of the many advantageous uses of the innovative teachings of the invention. In general, statements made in the specification of the present application do not necessarily limit any of the various claimed aspects of the present invention. Moreover, some statements may apply to some inventive features but not to others. In the drawings, like or similar elements are designated with identical reference numerals throughout the several views.

According to the preferred embodiment of the present invention, there is provided a method and system for sending instant messages of various kinds to participants involved into an ongoing conference call, such as for example into a multimedia, Session Initiation Protocol (SIP) based conference call. Although various types of identifiers may be used, the conference call is preferably identified by a Uniform Resource Identifier (URI). The conference call URI is dynamically updated during the ongoing conference call so that it is always associated to the participants currently involved in the conference call. When one of the participants to the conference desires to send an instant message to the other participants, the instant message is directed to the conference URI. An Application Server receives the message and translates the conference URI into the identities of the current participants, such as for example in their Public IDs. Then, the instant message is sent to each one of the current participants of the conference call. According to the invention, the instant message sent during the ongoing conference call may be of any kind, such as for example text, audio, video, data file, graphical or a combination thereof.

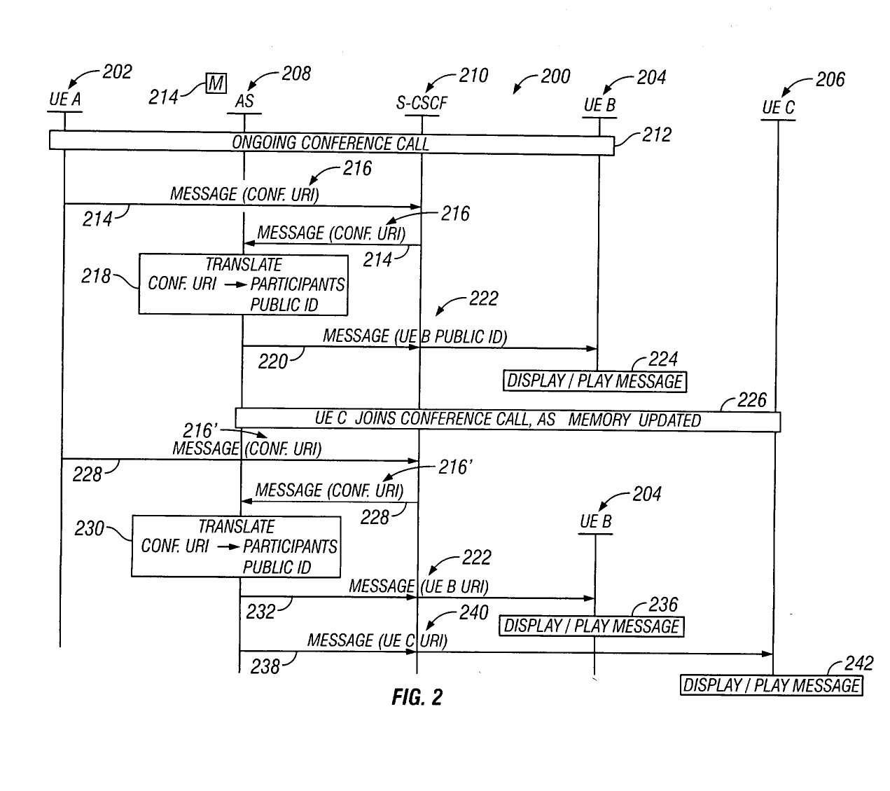

Reference is now made to FIG. 2, which is an exemplary illustration of a nodal operation and signal flow diagram of the preferred embodiment of the invention associated with the transmission of an instant message during an SIP conference call.

Shown in FIG. 2 is a packet-switched telecommunications network 200 comprising a User Equipment (UE) A 202, UE B 204, and UE C 206. The network 200 further comprises an Application Server (AS) 208 and a Serving Call State Control Function (S-CSCF) 210. It is understood that the network 200 may further comprise other types of nodes, which are not shown in FIG. 2 for the sake of simplicity. The network 200 may be any kind of fixed or cellular telecommunications network, such as for example but not limited to a Global System for Mobile telephony (GSM) based cellular telecommunications network, a General Packet Radio Service (GPRS) network, a Code Division Multiple Access (CDMA) cellular network, a CDMA2000 or a Wide-CDMA cellular network, an Enhanced Data rates for Global Evolution (EDGE) cellular network, or any other kind of network.

With reference being further made to FIG. 2, at the beginning in action 212 UE A 202 and UE B 204 are engaged in conference call such as for example in a SIP-based conference call, also called herein a conference call, that is identified by a conference call Uniform Resource Identifier (URI) and controlled by the AS 208, which thus stores the conference URI and the identity of each participant to the conference call. It is also assumed that filter criteria associated with the conference call URI route all messages to the AS 208. The conference call identifier may be stored in a memory M 214 of the AS 208, where it is associated with identities, preferably under the form of Public Ids, of the current participants to the conference call, which in the present case and moment are UE A 202 and UE B 204. In action 214, UE A 202 desiring to send an instant message to the other participant(s) to the conference call, sends a SIP Message 214 to the S-CSCF 210, the SIP Message comprising a destination under the form of the conference URI 216. Upon receipt of Message 214, the S-CSCF 210 relays the former to AS 208. The AS 208 extracts the conference URI 216 from the message, and using its memory-stored correspondence between the conference URI and the Public Ids of the current participants to the conference call, translates the conference URI into the identity of the other participants to the conference call, which in the present case is only UE B 204, action 218. In action 220, the AS 208 sends the Message issued by UE A 202 to the UE B 204, using the identity of the UE B that may for example be the Public ID 222 for of the UE. In action 224, the UE B 204 receives the Message 220, which is displayed, played or run, depending upon its nature, action 224.

Then, at a given point in time during the same conference call, another party, say UE C 206 joins the conference call, and the memory M 214 of AS 208 is updated so as to reflect the fact that the conference URI is now associated to the Public IDs of all three participants, i.e. to UE A 202, UE B 204, and UE C 206. The next instant message that UE A 202 sends to the other participants, which may also be an SIP Message 228, is also directed to the conference URI 216′ and reaches the S-CSCF 210 which further relays it to AS 208. The AS 208 extracts the conference URI 216′ from the Message, and using its memory-stored correspondence between the conference URI and the public Ids of the current participants to the conference call, translates the conference URI 216′ into the identity of the other participant to the conference call, which in the present case are UE B 204 and UE C 206, action 230. In action 232, the AS 208 sends the SIP Message issued by the UE A 202 to the UE B 204 using the Public ID 222 of the UE B, which displays, plays or run the message, depending upon its nature, action 236.

Likewise, in action 238, the AS 208 also sends the SIP Message issued by the UE A 202 to the UE C 206 using the public ID 240 of the UE C, which finally also displays, plays or run the message, depending upon its nature, in action 242.

The above-described call case scenario, also called herein the paging model scenario, allows for a flexible manner of sending instant messages of various forms to the participants of a conference call, without the need for establishing an additional dialogue, session or channel between the participants, on top of the ongoing conference call. Thus, each instant message is independent from the previous and the following one.

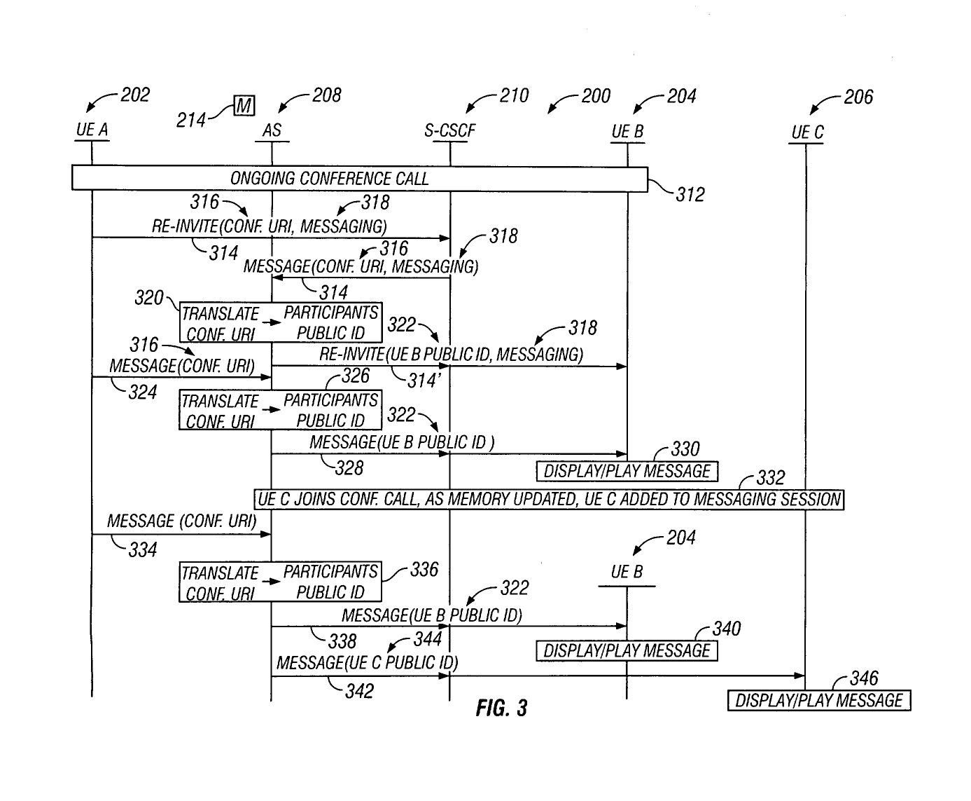

Reference is now made to FIG. 3, which is an exemplary illustration of a nodal operation and signal flow diagram of a variant of the preferred embodiment of the invention associated with the transmission of an instant message during an SIP conference call. According to this variant of the preferred embodiment of the invention, in order to exchange instant messages among participants to a conference call, a new messaging session is established along the ongoing conference call, or a new messaging channel is established within the existing conference call. It may be preferable to establish a new messaging channel for exchanging instant messages within the existing conference call when the instant messages are to be displayed, played or executed on the same terminal used by the participant for carrying on the original conference call. On the other hand, it may be preferable to establish a new messaging session along the current conference call when users are to be given the flexibility of selecting having the messaging session either on the same terminal where they carry on the conference call or on an alternate terminal. Shown in FIG. 3 is a packet-switched telecommunications network 200 comprising a User Equipment (UE) A 202, UE B 204, and UE C 206. The network 200 further comprises an Application Server (AS) 208 and a Serving Call State Control Function (S-CSCF) 210. It is understood that the network 200 may further comprise other types of nodes, which are not shown in FIG. 3 for the sake of simplicity. The network 200 may be any kind of fixed or cellular telecommunications network, such as for example but not limited to a Global System for Mobile telephony (GSM) based cellular telecommunications network, a General Packet Radio Service (GPRS) network, a Code Division Multiple Access (CDMA) cellular network, a CDMA2000 cellular network, an Enhanced Data rates for Global Evolution (EDGE) cellular network, or any other kind of network.

With reference being further made to FIG. 3, at the beginning in action 312 UE A 202 and UE B 204 are engaged in a conference call that may be identified by a conference call URI and controlled by the AS 208, which thus stores the conference URI and the identity of each participant to the conference call. It is also assumed that filter criteria or normal SIP routing associated with the conference call route all messages to the AS 208. The conference call identifier, which is preferably a conference call URI, may be stored in a memory M 214 of the AS 208 where it is associated with along with the Public ID of each current participant to the conference call, which in the present case and moment are only UE A 202 and UE B 204. According to the present variant of the preferred embodiment of the invention, in order to establish a new messaging channel to the existing conference call for exchanging instant messages with the other participant(s) to the conference call, in action 314, the UE A 202 sends a RE-INVITE message to the S-CSCF 210, which message comprises a destination under the form of the conference URI 316, and a messaging parameter 318 indicative of the fact that a new messaging channel is to be established within the current conference call. It is to be understood that although the present variant of the preferred embodiment is described with reference to establishing a new messaging channel, a new messaging session could as well be established along the ongoing conference call. In this former case the SIP Re-INVITE is replaced by a normal SIP INVITE message. Upon receipt of message 314, the S-CSCF 210 relays it to the AS 208, which based on the correspondence between the conference URI and the identity of the conference participants that is stored in its memory M 214, translates in action 320 the conference URI 316 into a Public ID of the other participant to the conference, i.e. into the Public ID 322 of the UE B 204. Then, the AS 208 sends a RE-INVITE message 314′ (or an INVITE message in case of the new messaging session setup, as described) with the Public ID 322 of UE B 204 and the messaging parameter 318 to UE B 204 for establishing the new messaging session. At this point, UE A 202 and UE B 204 are not only communicating through the original conference call of action 312, but also via a new messaging session, or via a messaging channel of the existing conference call).

In action 324, UE A 202 desires to send an instant message to the other participant(s) to the conference call, and therefore sends an SIP Message 324 to the AS 208, the message comprising a destination under the form of the conference URI 316. The AS 208 extracts the conference URI 316 from the SIP Message, and using its memory-stored correspondence between the conference URI and the Public Ids of the current participants to the conference call, translates the conference URI 316 into the Public ID of the other participant to the conference call, which in the present case is UE B 204, action 326. In action 328, the AS 208 sends the message issued from the UE A 202 to the UE B 204 using the Public ID 322 of the UE B. In action 330, the UE B 204 receives the message, which is displayed, played or run, depending upon its nature.

Then, at a given point in time during the same conference call, another party, say UE C 206 joins the conference call, and the memory M 214 is updated so as to reflect the fact that the conference URI is now associated to all three participants, i.e. to UE A 202, UE B 204, and UE C 206, action 332. Action 332 may include having UE C 206 that joins the conference call sending to the AS 208 via the S-CSCF 210 a RE-INVITE message similar to the one of action 314, and responsive to this, having the AS 208 perform service logic for connecting the UE B 206 with the other participants via the same messaging session, or channel.

The next instant message 334 issued by UE A 202 is also directed to the conference URI 316′ and reaches the AS 208, which extracts the conference URI 316′ from the message, and using its memory-stored correspondence between the conference URI and the identities of the current participants to the conference call, translates the conference URI 316′ into the Public IDs of the other participant to the conference call, which in the present case are UE B 204 and UE C 206, action 336. In action 338, the AS 208 sends the SIP Message issued by the UE A 202 to the UE B 204 using the Public ID 322 of the UE B, which displays, plays or run the message, depending upon its nature, in action 340. Likewise, in action 342, the AS 208 also sends the Message issued by the UE A 202 to the UE C 206 using the Public ID 344 of the UE C, which finally also displays, plays or run the message, depending upon its nature, in action 346.

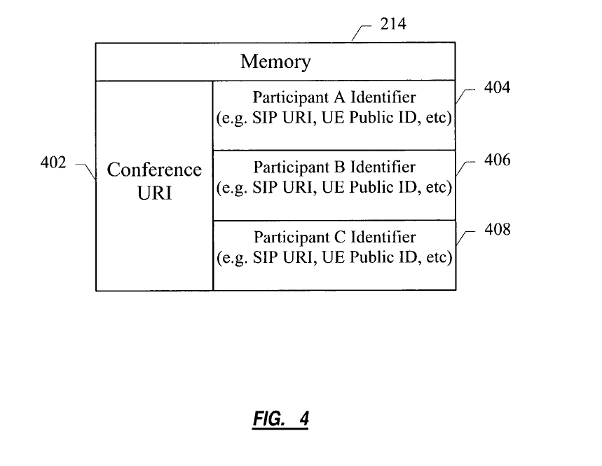

Reference is now made to FIG. 4, which shows an exemplary high-level logical diagram of the memory 214 of the AS 208 storing the correspondence between a conference call URI 402, and the identities of the participants to the conference call. In FIG. 4, these identities are exemplary represented as SIP URIs or Public IDs of the UEs 404-408 that participate to the conference call.

Based upon the foregoing, it should now be apparent to those of ordinary skills in the art that the present invention provides a flexible manner for exchanging instant messages of various kinds between the participants to a conference call, that is preferably carried on using SIP signaling. It is also to be noted by those skilled in the art that for simplicity purposed, the exemplary call case scenarios described in relation to FIG. 2 and 3 lack the confirmation messages, such as the known SIP 200 OK confirmation messages that typically follow receipt of each SIP instruction. Although the system and method of the present invention have been described in particular reference to certain call case scenarios, it should be realized upon reference hereto that the innovative teachings contained herein are not necessarily limited thereto and may be implemented advantageously with respect to other signaling scenarios. For example, although the exemplary scenarios described in relation to FIGS. 2-3 depict a translation between the conference call URI and a Public ID of each participant to the conference call, it is understood that other types of identifiers may be employed as well in connection with various preferred implementation. In particular, the conference call may be identified by any type of identifier, including the conference call URI, and the translation performed by the AS may be done toward any type of identifier for the participants to the conference call, including toward an SIP URI that may identify the participant or its terminal (UE). The participant identifier may be an UE Public UD as well, as described hereinbefore. It is believed that the operation and construction of the present invention will be apparent from the foregoing description. While the method and system shown and described have been characterized as being preferred, it will be readily apparent that various changes and modifications could be made therein without departing from the scope of the invention as defined by the claims set forth hereinbelow.

Although several preferred embodiments of the method and system of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

What is claimed is:

1. A method for exchanging instant messages between at least a first and second participants to a conference call, the method comprising the steps of:
during the conference call, sending an instant message, from the first participant, to the conference call identified by a conference call identifier;
translating the conference call identifier into an identifier of at least a second participant to the conference call; and
sending the instant message to the second participant to the conference call using the identifier of the second participant.

2. The method claimed in claim 1, further comprising the steps of:
receiving the instant message by the second participant; and
upon receipt of the instant message, displaying, playing or running the instant message on a User Equipment (UE) of the second participant.

3. The method claimed in claim 1, wherein the conference call identifier is a Uniform Resource Identifier (URI) and the identifier of the second participant is a Public ID of a User Equipment (UE) of the second participant.

4. The method claimed in claim 1, wherein the conference call identifier is a Uniform Resource Identifier (URI) and the identifier of the second participant is a Session Initiation Protocol (SIP) URI associated with the second participant.

5. The method claimed in claim 1, wherein the conference call is a Session Initiation Protocol (SIP) based conference call, and the instant message is an SIP Instant Message.

6. The method claimed in claim 3, further comprising the steps of:
joining the conference call by a third participant; and
updating a memory of an Application Server (AS) with the Public ID of the third participant;
wherein the memory of the AS stores a correspondence between the conference call URI and the Public ID of each current participant to the conference call.

7. The method claimed in claim 1, further comprising, prior to the step of sending the instant message, the steps of:
establishing the conference call between the at least the first and second participants; and
establishing a new messaging session between at least the first and the second participants to the conference call.

8. The method claimed in claim 7, wherein the messaging session is established using a Session Initiation Protocol (SIP) INVITE message sent by the first participant to the conference call using the conference call identifier, and wherein the SIP INVITE message is received by an Application Server (AS) that translates the conference call identifier into an identifier of the at least the second participant to the conference call, and relays the SIP INVITE message to the at least the second participant using the identifier of the at least the second participant.

9. The method claimed in claim 1, further comprising, prior to the step of sending the instant message, the steps of:
establishing the conference call between the at least the first and second participants; and
establishing a new messaging channel in the current conference call between at least the first and second participants to the conference call.

10. The method claimed in claim 7, wherein the messaging session is established using a Session Initiation Protocol (SIP) Re-INVITE message sent by the first participant to the conference call using the conference call identifier, and wherein the SIP Re-INVITE message is received by an Application Server (AS) that translates the conference call identifier into an identifier of the at least the second participant to the conference call, and relays the SIP Re-INVITE message to the at least the second participant using the identifier of the at least the second participant.

11. A telecommunications system comprising:
an Application Server (AS) handling a conference call; and
a first and a second participant to the conference call;
wherein during the conference call, the first participant sends an instant message to the conference call identified by a conference call identifier, the AS translates the conference call identifier into an identifier of at least the second participant to the conference call, and sends the instant message to the second participant to the conference call using the identifier of the second participant.

12. The telecommunications system claimed in claim 11, wherein:
when the second participant receives the instant message, a User Equipment (UE) of the second participant displays, plays or runs the instant message.

13. The telecommunications system claimed in claim 11, wherein the conference call identifier is a Uniform Resource Identifier (URI) and the identifier of the second participant is a Public ID of a User Equipment (UE) of the second participant.

14. The method claimed in claim 11, wherein the conference call identifier is a Uniform Resource Identifier (URI) and the identifier of the second participant is a Session Initiation Protocol (SIP) URI associated with the second participant.

15. The telecommunications system claimed in claim 10, wherein the conference call is a Session Initiation Protocol (SIP) conference call, and the instant message is an SIP Instant Message.

16. The telecommunications system claimed in claim 13, further comprising:
a third participant joining the conference call;
wherein the AS comprises a memory that stores a correspondence between the conference call URI and a Public ID of each current participant to the conference call, and wherein the AS updates its memory with the Public ID of the third participant when the third participant joins the conference call.

17. The telecommunications session claimed in claim 11, wherein prior to sending the instant message from the first participant, the conference call is established between the first and second participants, and a new messaging session is also established between the first and second participants.

18. The telecommunications session claimed in claim 17, wherein the messaging session is established using a Session Initiation Protocol (SIP) INVITE message sent from the first participant, to the conference call using the conference call identifier, and wherein the SIP INVITE message is received by the Application Server (AS) that translates the conference call identifier into an identifier of the second participant, and relays the SIP INVITE message to the second participant using the identifier of the second participant.

19. The telecommunications session claimed in claim 11, wherein prior to sending the instant message from the first participant, the conference call is established between the first and second participants, and a new messaging channel is established in the ongoing conference call between the first and second participants.

20. The telecommunications session claimed in claim 19, wherein the messaging channel is established using a Session Initiation Protocol (SIP) Re-INVITE message sent from the first participant, to the conference call using the conference call identifier, and wherein the SIP Re-INVITE message is received by the Application Server (AS) that translates the conference call identifier into an identifier of the second participant, and relays the SIP Re-INVITE message to the second participant using the identifier of the second participant.
